(19) United States
(12) Patent Application Publication
(10) Pub. No.: US 2011/0282883 A1
(43) Pub. Date: Nov. 17, 2011

(54) INDEXING SERVER AND METHOD THEREFOR

(75) Inventors: Yongqiang Liu, Beijing (CN); Yong Xia, Beijing (CN); Yan Hu, Beijing (CN); Quan Huang, Beijing (CN)

(73) Assignee: NEC (CHINA) CO., LTD., Beijing (CN)

(21) Appl. No.: 13/125,684

(22) PCT Filed: Mar. 26, 2010
(86) PCT No.: PCT/CN2010/000379

§ 371 Date: Apr. 22, 2011

(51) Int. Cl. G06F 17/30

(52) U.S. Cl. 707/741; 707/E17.037

(57) ABSTRACT

An indexing server of a P2P network and a method therefor are provided. The indexing server comprises: a metadata storage unit, which stores one or more entries, each of which is associated with a data file and includes a plurality of information items each indicating a node offering the data file and a location of the node; and a node information managing unit, which monitors the metadata storage unit to identify an entry stored in the metadata storage unit in which the number of information items exceeds a threshold, and transfers a portion of the information items included in the identified entry to another server, the transferred portion including as many as possible such information items that indicate nodes whose locations are close to each other.

### FIELD OF THE INVENTION

The invention generally relates to Peer-to-Peer (P2P) network, and in particular, to an indexing server of the P2P network and a method therefor.

### BACKGROUND

P2P network is a distributed network formed by a plurality of users in ad hoc manner. These users can be referred to as “nodes”. The nodes can share various resources, such as data files, computation power, storage capability, and bandwidth. A data file, also referred to as “data” or “file” hereinafter, may include an image file, an audio file, a video file, or the like. When a node wants to download a file, it has to know which nodes in the P2P network have that file, that is, can offer that file. An existing P2P system typically uses a centralized indexing server to store metadata of files. The metadata of a file describes the properties of the file, for example, the size of the file, and the nodes that can offer the file. This metadata may be reported to the indexing server by the nodes that can offer the file. Upon receiving a request from the node that wants to download the file (the “requesting node”), the indexing server notifies the requesting node of a subset of the nodes that can offer the file by referring to the metadata of the information. The transmission of the file then occurs between the requesting node and the subset of the nodes.

Typically, an existing indexing server will randomly choose such a subset to notify to the requesting node. Such a random reply will result in a significant “cross-ISP traffic” problem. That is, a node served by a first Internet Service Provider (ISP), ISP1, or in other words, in ISP1, will download data from a node in ISP2, even though another node in ISP1 also has the data available for download.

To reduce cross-ISP traffic, a location-aware storage structure has been proposed to store metadata for a large-scale P2P network system.

The storage and search for metadata information for a large-scale P2P network can be described as follows.

Assuming a metadata table of the size of 0 (N×D), where D is the total number of the files shared in the P2P network, and N is the total number of nodes in the P2P network. The metadata table includes D pieces of metadata associated with the D files respectively. A piece of metadata associated with a file will also be referred to as for example “the metadata of the file” or “the metadata entry associated with the file” hereinafter. A metadata entry may include one or more node information items each describing a node offering the file.

1. How to distribute the metadata entries of the respective files among a plurality of indexing server in a scalable manner.

2. When a request Req(M, Dᵢ, T) is received from a requesting node, where M is the identification (for example, IP address) of the requesting node, Dᵢ is the identification of the desired file, and T is the number of the node information items (for example, the addresses of the nodes) associated with file D, that the node M desires to acquire, then a response should be constructed as follows:
i) if the number of the node information items associated with file D, in the metadata table is less than or equal to T, then return as many node information items to the requesting node M as possible;
ii) if the number of the node information items associated with file Dᵢ in the metadata table is greater than T, then select T node information items from the node information items associated with file D, selected T node information item should indicate nodes that are as close to the requesting node as possible.

A location of a node herein may be defined as (ISP, region), indicating the Internet Service Provider serving the node, and the geographical region of the node, for example. The “closeness” between nodes and the requesting node is defined as follows. For two nodes A and B, if node A is in the same ISP with the requesting node, while node B is not, then node A is closer to the requesting node than node B. If both nodes A and B are in the same ISP with the requesting node or neither A nor B are in the same ISP with the requesting node, and if node A is in the same region with the requesting node while node B is not, then node A is closer to the requesting node than node B. In addition, if both nodes A and B are in the same ISP and the same region with the requesting node, or if both nodes A and B are in the different ISP and different region from the requesting node, then nodes A and B can be ordered randomly in terms of their “closeness” to the requesting node.

In CN101355591 entitled “A P2P Network and A Scheduling Method Therefor” by JiPing Shao, the metadata table is distributed in the file dimension. Specifically, a plurality of indexing servers form a DHT network. The metadata of each file is stored in a corresponding indexing server according to the ID of the file. When a requesting node is requesting a data file, or more specifically, the information regarding nodes that can offer the data file, the requesting node sends a request to its home indexing server. The request is routed in the DHT network to a destination indexing server, which is assigned to store the metadata of the file based on the ID of the file. The destination indexing server transmits the metadata of the file to the home indexing server, and the home indexing server orders the nodes indicated by the metadata according to their “closeness” to the requesting node, and notifies the requesting node of the N closest nodes.

Specifically, each indexing server maintains a local Finger Table. When a request is received, the indexing server performs a DHT lookup on the Finger Table. If the indexing server stores the metadata of the requested file, a hit will occur. Otherwise, the Finger Table will point to the next hop indexing server, to which the request will be routed. The DHT algorithm can guarantee that the number of hops traversed by a request is O(log(n)), where n is the number of the indexing servers in the DHT network. The implementation details of the DHT algorithm can be found in I. Stoica, R. Morris, D. Karger, M. F. Kaashoek, and H. Balakrishnan, Chord: A Scalable Peer-to-peer Lookup Service for Internet Applications, In Proceedings of SIGCOMM 2001, San Deigo, Calif., August 2001.

As can be appreciated, as the number of nodes in the P2P network that offer a data file gets larger and larger, the size of the metadata entry associated with the data file stored in the corresponding indexing server increases accordingly. For example, as reported by operation data for PPLive (Gale Huang, PPLive—A Practical P2P Live System with Huge Amount of Users), there were over 250 thousand users at peak time that watched the online live video of the popular TV show “Super Girl” in 2005. Thus, it will be difficult to store the information regarding all these users (nodes) in the one server that is assigned to store the node information of the data file “Super Girl” live video. Meanwhile, when a request for node information associated with a data file is received from a requesting node, the server has to spend a lot of time sorting all the nodes offering the data file by location, which will result in an unacceptable delay in responding to the requesting node.

Thus, a need exists for an indexing server and a method for operating the same which can store and search metadata for a P2P network in an efficient way.

### SUMMARY OF THE INVENTION

To address the above and other problems, an indexing server of a P2P network and a method therefor are provided.

According to an aspect of the invention, there is provided an indexing server of a peer-to-peer network, comprising: a metadata storage unit, which stores one or more entries, each of which is associated with a data file and includes a plurality of information items each indicating a node offering the data file and a location of the node; and a node information managing unit, which monitors the metadata storage unit to identify an entry stored in the metadata storage unit in which the number of information items exceeds a threshold, and transfers a portion of the information items included in the identified entry to another server, the transferred portion including as many as possible such information items that indicate nodes whose locations are close to each other.

According to another aspect of the invention, there is provided a method for an indexing server of a peer-to-peer network, the indexing server including a metadata storage unit which stores one or more entries, each of which is associated with a data file and includes a plurality of information items each indicating a node offering the data file and a location of the node, the method comprising the steps of: monitoring the metadata storage unit to identify an entry stored in the metadata storage unit in which the number of information items exceeds a threshold; and transferring a portion of information item included in the identified entry to another server, the transferred portion including as many as possible such information items that indicate nodes whose locations are close to each other.

### DESCRIPTION OF THE DRAWINGS

The above and other features and advantages of the invention can be better understood by reading the detailed description below in connection with the drawings, in which same or similar reference signs are used to designate same or similar elements, in which:

FIG. 1 is a block diagram showing an indexing server according to a first embodiment of the invention;

FIG. 2 is a flowchart showing operations of a node information managing unit of the indexing server of the first embodiment;

FIG. 3 is a flowchart showing operations of a message handling unit, a node information searching unit and the other components of the indexing server according to the first embodiment;

FIG. 4 is a flowchart showing in more detail the operations of the node information searching unit of the indexing server of the first embodiment;

FIG. 5 is a block diagram showing an indexing server according to a second embodiment of the invention;

FIG. 6 is a flowchart showing operations of a message handling unit, a node information searching unit, a DHT lookup unit and the other components of the indexing server according to the second embodiment;

FIG. 7 is a block diagram showing an indexing server according to a third embodiment of the invention; and

FIG. 8 is a flowchart showing operations of a message handling unit and other components of the indexing server according to the third embodiment.

### DETAILED DESCRIPTION

The embodiments of the invention will be described in detail below with reference to the drawings.

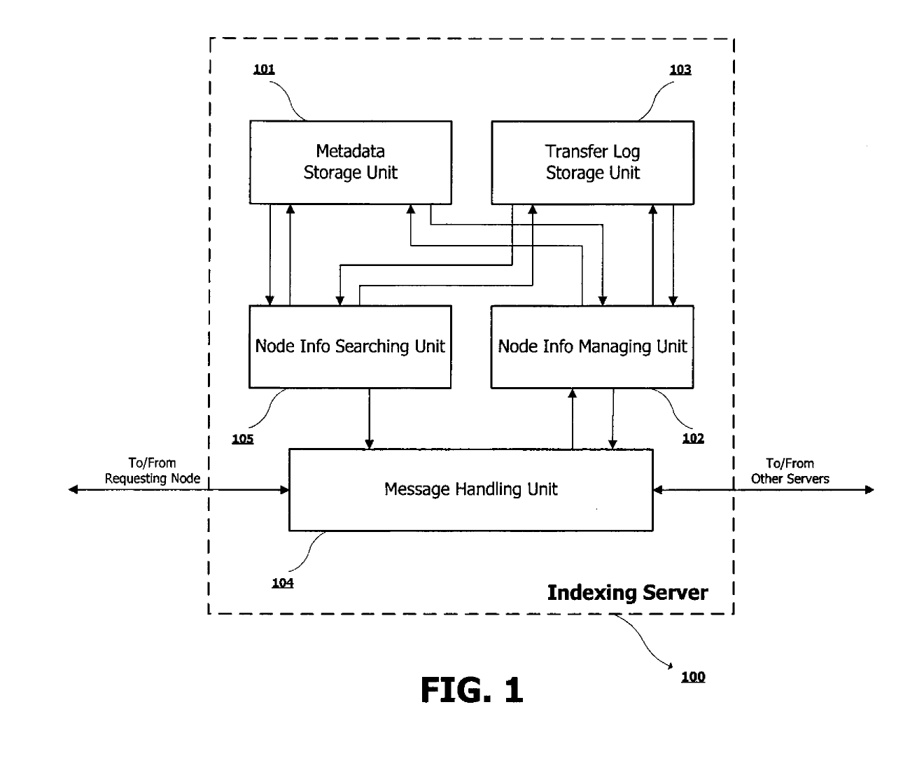

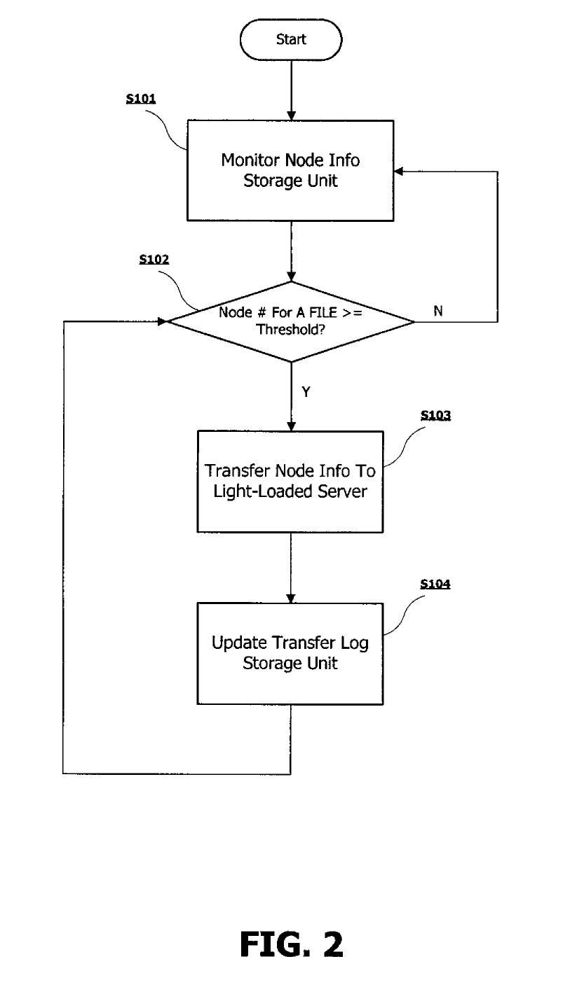

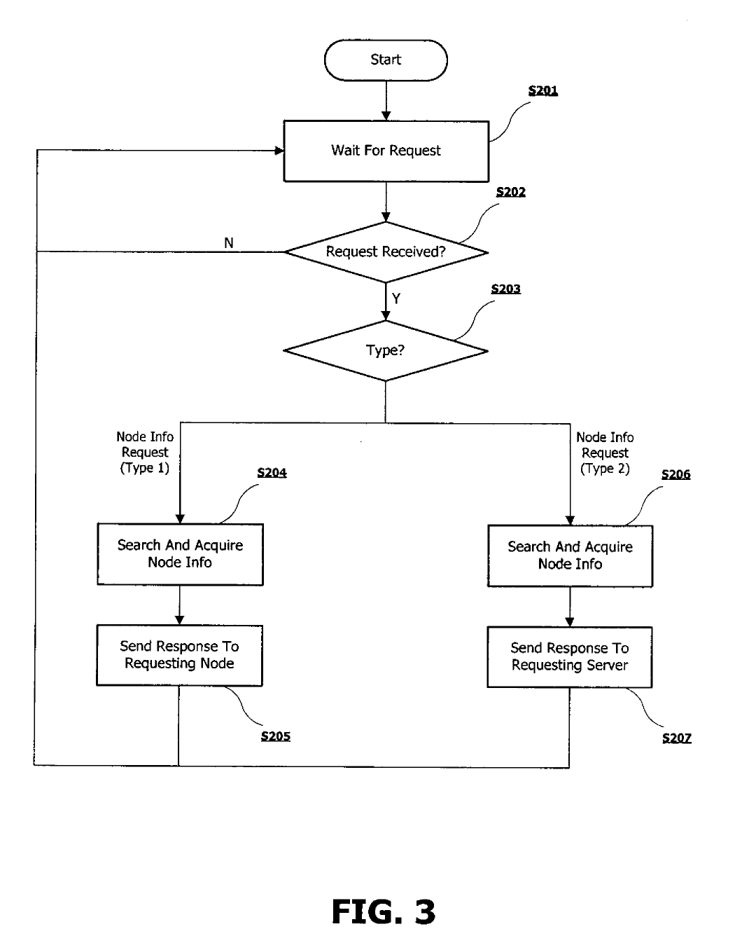

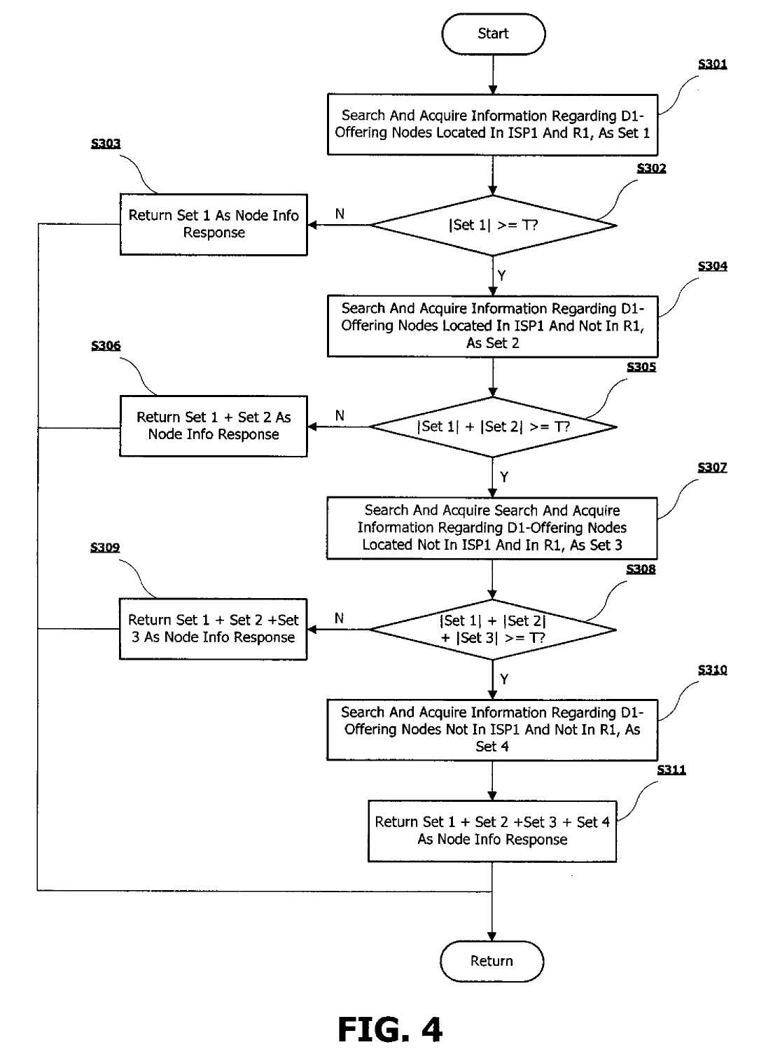

FIG. 1 is a block diagram showing an indexing server 100 according to a first embodiment of the invention. FIG. 2 is a flowchart showing operations of a node information managing unit 102 of the indexing server 100 of the first embodiment. FIG. 3 is a flowchart showing operations of a message handling unit 104, a node information searching unit 105 and the other components of the indexing server 100 according to the first embodiment. FIG. 4 is a flowchart showing in more detail the operations of the node information searching unit 105 of the indexing server 100 of the first embodiment. The structures and operations of the indexing server 100 will be described below in connection with FIGS. 1-4.

The indexing server 100 includes a metadata storage unit 101, a node information managing unit 102, a transfer log storage unit 103, a message handling unit 104, and a node information searching unit 105.

The metadata storage unit 101 stores metadata for a P2P network. Specifically, the indexing server 100 may be assigned to store metadata associated with one or more data files shared in the P2P network. Those skilled in the art can appreciate different ways of assigning an indexing server to store metadata associated with a data file, one of which is to determine the indexing server for storing a data file according to the ID of the data file as in a DHT network, as described in the “Background” above and in the second embodiment below. However, the invention is not limited to any specific way of assigning, specifying, or determining an indexing server for storing metadata for a specific data file.

More specifically, the metadata storage unit 101 stores one or more metadata entries, each of which is associated with a different one of the one or more data files. Each entry includes one or more node information items. Each node information item indicates a node that is known to offer the associated data file, and the location of the node. For example, an entry stored in the metadata storage unit 101 may take the following form:

data_id: node_id1(ip1, port1, location1), node_id2(ip2, port2, location1), . . . ,

where data_id is the identification (ID) of the data file associated with the entry, node_id1(ip1, port1, location1) is a node information item which indicates a node offering the data file, where the ID of the node is node_id1, the address of the node is (ip1, port1), and the location of the node is location1. As described above, the location of the node may be defined as (ISP, Region).

Those skilled in the art can appreciate that the metadata of a data file can include information about other properties of the file, for example, the size of the file. These properties are omitted here for brevity.

The node information managing unit 102 monitors the metadata storage unit 101 to determine whether there is an entry stored in the metadata storage unit in which the number of node information items exceeds a threshold, and, in response to a positive determination, transfers a portion of the node information items to another server, the transferred portion including as many as possible such node information items that indicate nodes whose locations are close to each other.

Turning to FIG. 2, the operations of the node information managing unit 102 will be described in detail. As shown in FIG. 2, the node information managing unit 102 constantly or periodically monitors the metadata storage unit 101 in step S101 and determines whether there is an entry stored in the metadata storage unit 101 in which the number of node information items exceeds a threshold, or in other words, whether the number of nodes offering a data file the storage of metadata of which is assigned to the indexing server 100 has become larger than a threshold.

If the result of the determination is negative, the process returns to step S101 in which the node information managing unit 102 continues to monitor the metadata storage unit 101, otherwise, the process proceeds to step S103.

For example, assuming that the indexing server 100 is assigned to store metadata entry associated with a data file D1. When the number of nodes in a P2P network that can provide the data file D1 gets larger and larger, the number of the node information items in the entry associated with the data file D1 stored in the metadata storage unit 101 will raise above a threshold, say TH1.

In this case, in step S103, the node information managing unit 102 will initiate a transfer process, during which some or all of the node information items in the entry in which the number of node information items gets too large will be transferred to another light-loaded server. The transferred portion including as many as possible such node information items that indicate nodes whose locations are close to each other.

For example, the node information managing unit 102 divides the node information items included in the entry into one or more groups by ISP, such that each of the groups includes node information items indicating nodes in a different ISP. The node information managing unit 102 then determines the numbers of node information items in the respective groups, and identifies the group in which the number of the node information items is the largest (which will be referred to as the largest group hereinafter) among the one or more groups. Then, the node information managing unit 102 may determine whether the number of node information items in the largest group is greater than a threshold, for example, the threshold TH1. If the result of the determination is negative, the node information managing unit 102 will transfer the group of node information items from the indexing server 100 to another indexing server whose load is determined to be light, in other words, another indexing server that does not have too much node information stored therein at the current moment. Those skilled in the art can understand various ways of determining such a light-loaded server, and the invention is not limited to any specific way. As an example of a simple and efficient way, the indexing server 100 may randomly choose two other indexing servers from a list of indexing servers that serve the same P2P network as the indexing server 100, and choose the one with the lighter load as the destination for node information transfer.

On the other hand, if the number of node information items in the largest group is greater than the threshold, the node information managing unit 102 may further divide the node information items included in the largest group into one or more subgroups by region, such that each subgroup includes node information items indicating nodes in a different region. The node information managing unit 102 may then transfer a subgroup in which the number of node information items is largest among the one or more subgroups to a light-loaded server. In addition, the node information managing unit 102 may also transfer other subgroups into one or more other light-loaded servers.

If, after the node information items in the largest group has been transferred to one or more other indexing servers, the number of the remaining node information items in the entry is still larger than the threshold, the node information managing unit 102 may repeat the above process with respect to the remaining node information items, until the number of remaining node information items in the entry is smaller than the threshold.

The node information managing unit 102 may repeat the above process with respect to any other entry in the metadata storage unit 101 in which the number of node information items exceeds the threshold.

Turning back to FIG. 1, as shown therein, the indexing server 100 also includes a transfer log storage unit 103. The transfer log storage unit 103 may store a table of transfer logs. Therefore, when in step S103 part or all of the node information items in an entry is transferred to another server, the node information managing unit 102 in step S104 updates the transfer log storage unit 103.

Specifically, the node information managing unit 102 creates or updates a transfer log in the transfer log storage unit 103 such that the transfer log reflects the data file associated with the transferred portion, the other server to which the portion is transferred to, and the location range (for example, (ISP, Region)) of the nodes indicated by the transferred portion.

For example, the table may take the following form.

TABLE 1
the structure of the transfer log table

| | | | Number of Node | |
|---|---|---|---|---|
| Data ID | ISP | Region | information items | Indexing Server |
| D1 | ISP1 | R1 | 20 | IS-I |
| D1 | ISP1 | R2 | 10 | IS-II |
| D1 | ISP2 | R1 | 5 | IS-III |
| D1 | ISP3 | MR | 15 | 1S-IV |
| . . . | . . . | . . . | . . . | . . . |

Table 1 indicates that information regarding 20 nodes that offer data file D1 and are located in (ISP1, R1) has been transferred to indexing server IS-I, information regarding 10 nodes that offer data file D1 and are located in (ISP1, R2) has been transferred to indexing server IS-II, information regarding 5 nodes that offer data file D1 and are located in (ISP2, R1) has been transferred to indexing server and information regarding 15 nodes that offer data file D1 and are located in ISP3 has been transferred to indexing server IS-IV. The “MR” in the table indicates that the information transferred to indexing server IS-IV is regarding nodes that are in ISP3 and in more than one region.

In addition, if, after some node information items have been transferred to the other server, a node information item is received in the future which indicates a node who offers the data file associated with the transferred node information items and whose location is close to the nodes indicated by the transferred node information items, the node information managing unit 102 transfers the received node information item also to the other server, and updates the transfer log table accordingly. For example, if in the future the indexing server 100 receives information indicating that a node in (ISP1, R1) can offer data file D1 (which may be reported by that node), the information can be forwarded to the indexing server IS-I to stored therein, and the number “20” in the first line of Table 1 can be updated to “21”, for example.

Furthermore, an indexing server that receives node information transferred from the indexing server 100 can also monitor its own metadata storage unit and initiate a transfer process, similarly as the indexing server 100. Continuing the above example, the indexing server IS-I, after receiving the node information transferred from the indexing server 100, can save them as an entry associated with data file D1 in its own metadata storage unit. The indexing server IS-I then can also constantly or periodically monitor its own metadata storage unit, and determine whether any of the entries stored in its own metadata storage unit, including the entry associated with D1 and entries associated with the data files whose node information the indexing server IS-I is assigned to store, includes too many node information items, and initiate a transfer of node information items in that entry to a light-loaded server and updates its own transfer log table accordingly.

Turning back to FIG. 1, the indexing server 100 also includes a message handling unit 104. The message handling unit 104 handles messages received from and/or transmitted to a device external to the indexing server 100. For example, the messages received may be requests from external devices for node information. In this case, the message handling unit 104 listens to requests, determines the types of the received requests, and causes the other components of the indexing server 100 to act accordingly based on the types of the received messages. The message handling unit 104 also constructs and transmits messages to external devices as instructed by other components of the indexing server 100. The operations of the message handling unit 104 and the other components in this case will be described in details below in connection with FIG. 3.

As shown in FIG. 3, in step S201, the message handling unit 104 waits to receive a request from an external device, and in step S202, the message handling unit 104 determines whether a request has been received. If not, it returns to step S201, otherwise, the message handling unit 104 proceeds to determine the type of the request in step S203.

Specifically, the external device may be a node (the “requesting node”) in a P2P network that wants to download a data file from other nodes (peers of the requesting node) in the P2P network and thus needs to know which nodes can provide the data file.

In the case that the external device is the requesting node, the request may be a node information request that is made by the requesting node for information regarding a number T of nodes offering a specified data file and is received by the indexing server 100 from the requesting node directly or indirectly via other intermediate devices. Such a node information request is also referred to as “type 1 node information request” hereinafter, as shown in FIG. 3.

Alternatively, the external device may also be another indexing server that, during a process of node information search performed therein, decides to acquire node information associated with a data file from the indexing server 100, after the other server has transferred a portion of node information items associated with the data file to the indexing server 100 during a prior monitoring and transferring process in a similar manner as described above for indexing server 100. The other indexing server may be referred to as a requesting server. In this case, the request received from the requesting server may be a node information request made for information regarding a number of N nodes offering a specified data file, for example. Such a node information request is also referred to as “type 2 node information request” hereinafter, as shown in FIG. 3.

If the received request is a type 1 node information request as determined in step S203, the message handling unit 104 will cause the node information searching unit 105 to search and acquire the requested node information in step S204, and will return the acquired node information to the requesting node in step S205.

On the other hand, if the received message is a type 2 node information request as determined in step S203, the message handling unit 104 will cause the node information searching unit 105 to search and acquire the requested node information in step S206, and will return the acquired node information to the requesting server in step S207.

It is to be noted that in addition to the two types of requests as described above, the message handling unit 104 of course can handle other messages, signals, data, information, or the like. For example, the external device can also be a transfer source server that decides to transfer node information to the indexing server 100, and in this case the message received may be a message indicating transfer of node information initiated by the transfer source server, together with or separate from the node information items to be transferred. In this case, the message handling unit 104 will cause the metadata storage unit 101 to store the node information items transferred from the transfer source server in association with the relevant data file.

Turning back to FIG. 1, as shown therein, the indexing server 100 also includes a node information searching unit 105. The node information searching unit 105 is operable to, according to a request for information regarding nodes offering a specified data file for a requesting node, perform a node information search in the metadata storage unit 101 and the transfer log storage unit 103 to acquire, from at least one of the metadata storage unit 101 and another server to which a portion of the node information items associated with the specified data file has been transferred to, node information items that indicate nodes offering the specified data file and are located as close as possible to the requesting node. The operation of the node information searching unit 105 will be described in detail below in connection with the flowchart shown in FIG. 4.

Assuming that a request is for information indicating a number T of nodes from which a requesting node served by ISP1 and located in Region R1 can acquire a data file D1. The node information searching unit 105 can perform a node information search process according to such a request.

The process starts in step S301, in which the node information searching unit 105 searches and acquires as many as possible, but not greater than T, node information items indicating nodes that can offer D1 and are located in ISP1 and R1, as Set 1. For example, the node information searching unit 105 may first search the transfer log table stored in the transfer log storage unit 103, to determine whether there is a transfer log associated with D1 and (ISP1, R1). If so, the node information searching unit 105 determines whether the number of transferred node information items indicated in that log is greater than or equal to T. If the number is greater than or equal to T, the node information searching unit 105 instructs the message handling unit 104 to send to the indexing server indicated in the log(for example, “IS-I”) a type 2 node information request which requests T nodes offering D1 and located in (ISP1, R1). After receiving the node information response from the indexing server IS-I, the node information searching unit 105 may use the node information items included in the response as Set 1. However, if the number indicated in the log is less than T, then after acquiring the indicated number of node information items from the indexing server IS-I in a similar manner, the node information searching unit 105 may try to find a desired node information item from its own metadata storage unit 101. However, if as described above, all the information regarding nodes offering D1 and located in (ISP1, R1) received after the initial transfer of information regarding D1-offering nodes in ISP, R1) is performed has also been transferred to indexing server IS-I, then the probability that the node information searching unit 105 will find the desired node information item regarding a D1-offering node located in ISP, R1) in its own metadata storage unit 101 will be very low. In an embodiment, the node information searching unit 105 can skip searching its own metadata storage unit 101 in this case to save time.

However, if the transfer log table shows that no information regarding D1-offering nodes located in (ISP1, R1) has been transferred to any other server, then the node information searching unit 105 can search its own metadata storage unit 101 to find as much as possible and not greater than T node information items to use as Set 1.

In step S302, the node information searching unit 105 determines whether the number of node information items included in Set 1 (which will be denoted as |Set| thereafter, and this also applies to other sets) is larger than or equal to T. If so, then in step S303, the node information searching unit 105 instructs the message handling unit 104 to return Set 1 as the node information response to a requesting node (in case of type 1 node information request) or a requesting server (in case of type 2 node information request).

On the other hand, if |Set 1| is less than T, the search process proceeds to step S304, in which the node information searching unit 105 searches and acquires as many as possible, but not greater than (T−|Set 1|), node information items indicating nodes that can offer D1 and are located in ISP1 but not located in R1, as Set 2, in a similar manner as in step S301. In step S305, the node information searching unit 105 determines whether the sum of (|Set 1|+Set 2|) is larger than or equal to T. If so, then in step S306, the node information searching unit 105 instructs the message handling unit 104 to return the union of Set 1 and Set 2 as the node information response to a requesting node or a requesting server.

If the sum is less than T, the search process proceeds to step S307, in which the node information searching unit 105 searches and acquires as many as possible, but not greater than (T−|Set 1|−Set 2|), node information items indicating nodes that can offer D1 and are not located in ISP1 but are located in R1, as Set 3, in a similar manner as in step S301. In step S308, the node information searching unit 105 determines whether the sum of (|Set 1|+|Set 2|+|Set 3|) is larger than or equal to T. If so, then in step S309, the node information searching unit 105 instructs the message handling unit 104 to return the union of Set 1, Set 2, and Set 3 as the node information response to a requesting node or a requesting server.

Otherwise, the search process proceeds to step S310, in which the node information searching unit 105 searches and acquires as many as possible, but not greater than (T−|Set 1|−|Set 2|−|Set 3|), node information items indicating nodes that can offer D1 and are not located in ISP1 and are not located in R1, as Set 4. Note that in this step the node information searching unit 105 does not have to search the transfer log table and acquire node information items from other severs, and can simply randomly retrieve (T−|Set 1|−|Set 2|−|Set 3|) number of node information items associated with D1 from its own metadata storage unit 101. Finally, in step S311, the node information searching unit 105 instructs the message handling unit 104 to return the union of Set 1, Set 2, Set 3, and Set 4 as the node information response to a requesting node or a requesting server.

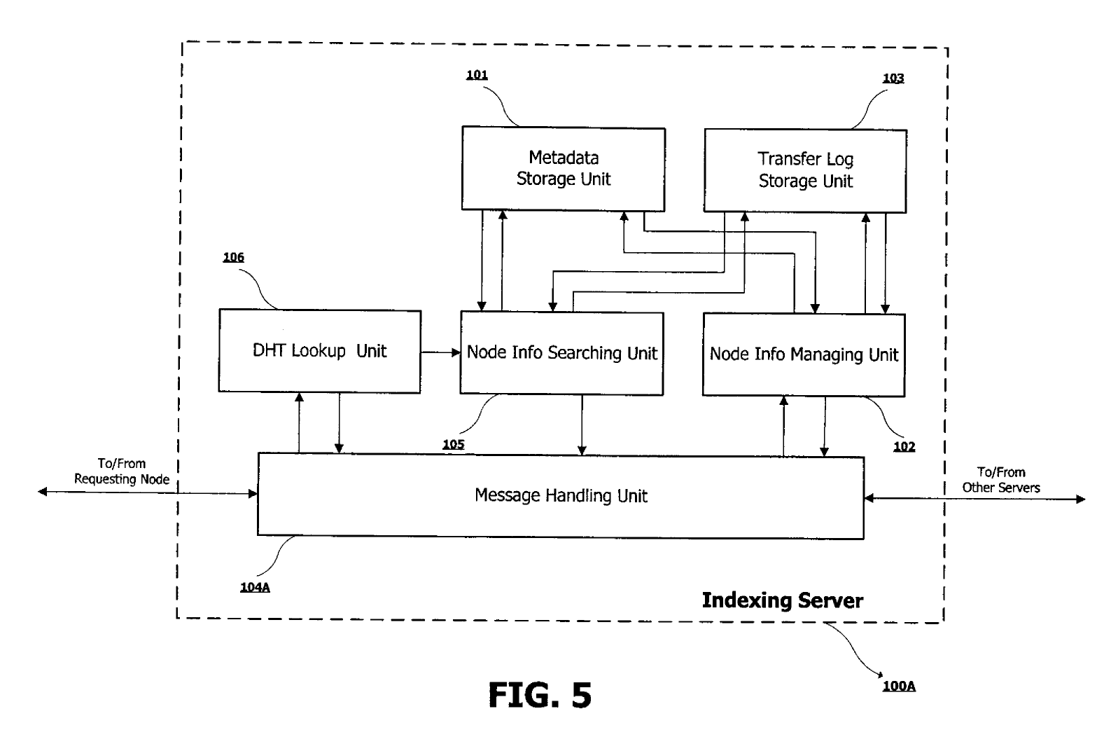

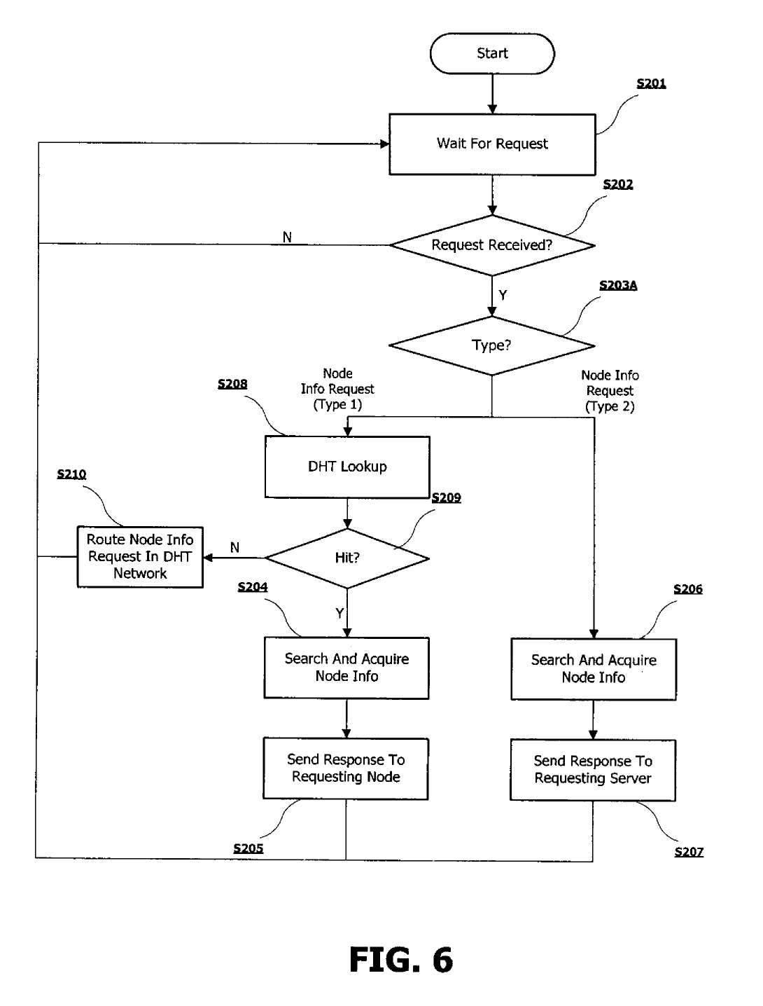

FIG. 5 is a block diagram showing an indexing server 100A according to a second embodiment of the invention. FIG. 6 is a flowchart showing operations of a message handling unit 104A, a node information searching unit 105, a DHT lookup unit 106 and the other components of the indexing server 100A according to the second embodiment. Those elements identical or similar to those of the first embodiment will be denoted by identical or similar reference signs, and the description thereof will be omitted.

As shown in FIG. 5, the indexing server 100A includes a metadata storage unit 101, a node information managing unit 102, a transfer log storage unit 103, a message handling unit 104A, a transfer log storage unit 103, and a DHT lookup unit 106.

The second embodiment represents an application of the present invention in a Distributed Hash Table (DHT) network. In this embodiment, the indexing server 100A is in a DHT network. In this case, the node information requests that the indexing server 100A can receive can also include the type 1 node information request and type 2 node information request as described above. The type 1 node information request is a request sent directly from the requesting node (in the event that the indexing server 100A is the home indexing server of the requesting node), or a request issued by the requesting node and routed by other indexing servers in the DHT network to the indexing server 100A. The type 1 node information request will not explicitly specify the indexing server 100A as the destination indexing server. If such a request is received, the DHT lookup unit 106 performs a DHT lookup and the indexing server 100A will act accordingly. Like the first embodiment, the type 2 node information request in the second embodiment can also be the node information request sent from another server when the other server is performing a node information search and finds that it can acquire the desired node information from the indexing server 100A. The type 2 node information request will explicitly specify the indexing server 100A as the destination indexing server. If such a request is received, the node information searching unit 105 directly performs a node information search, and the indexing server 100A will act accordingly.

The operation of the indexing server 100A will be described in connection with FIG. 6.

After a request is received in steps S201 and S202, the message handling unit 104A determines the type of the request in step S203A. If the request is a type 1 node information request, then the process proceeds to step S208, in which the DHT lookup unit 106 performs a DHT lookup by using a local Finger Table (not shown) maintained by the indexing server 100A. In step S209, the DHT lookup unit 106 determines whether the lookup on the local Finger Table hits. If a hit occurs, the process proceeds to step S204, in which the node information searching unit 105 is caused to search and acquire node information according to the request, and then in step S205, the acquired node information is sent to the requesting node as response. Please note that if the indexing server 100A is not the home indexing server of the requesting node, the indexing server 100A may send the acquired node information to the requesting node via the home indexing server.

On the other hand, if no hit occurs in step S209, then the process proceeds to step S210, in which the DHT lookup unit 106 instructs the message handling unit 104A, for example, to send the node information request to a next hop server pointed to by the Finger Table.

If the request is a type 2 node information request as determined in step S203A, then the process proceeds to step S206, in which the node information searching unit 105 searches and acquires node information according to the request, and then in step S207, the acquired node information is sent to the requesting server as response.

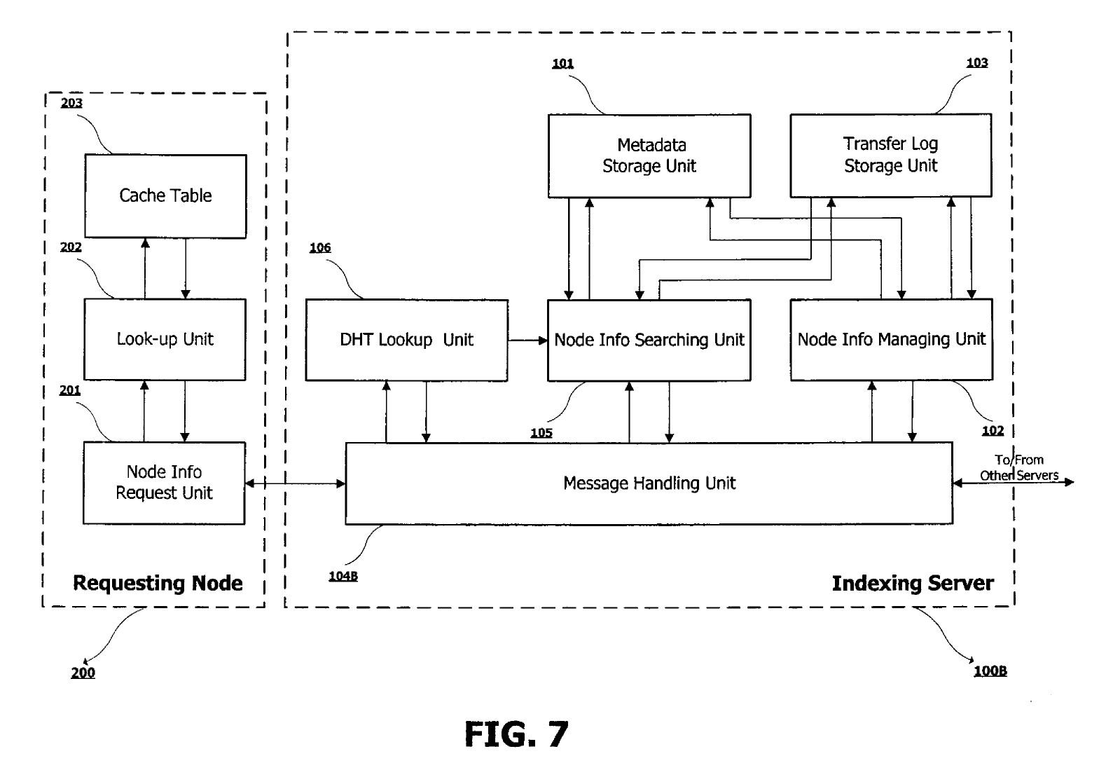

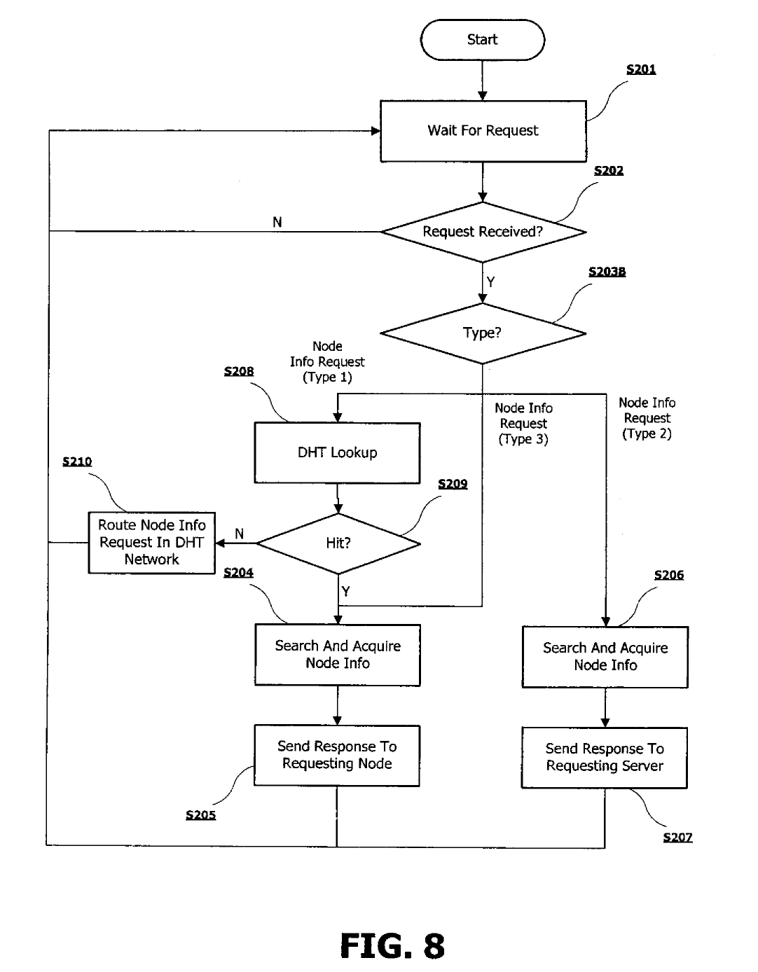

FIG. 7 is a block diagram showing an indexing server 100B according to a third embodiment of the invention. FIG. 8 is a flowchart showing operations of a message handling unit 104B and other components of the indexing server 100B according to the third embodiment. Those elements identical or similar to those of the second embodiments will be denoted by identical or similar reference signs, and the description thereof will be omitted.

As shown in FIG. 7, the third embodiment includes a modification to a requesting node. In the second embodiment, a request associated with a data file issued by the requesting node will be sent to the home indexing server first, and may be routed in the DHT network until it reaches the destination indexing server, i.e., the server that finds a hit in its local Finger Table. If subsequent requests associated with the data file can be directly sent to the destination indexing server, the delay of the response will be further reduced. Such a subsequent request that is sent by the requesting node and explicitly specifies a destination indexing server will be referred to as a type 3 node information request herein.

To this end, the requesting node 200 shown in FIG. 7 includes a node information requesting unit 201, a lookup unit 202, and a cache unit 203. After a node information response associated with a specific data file and indicating the destination indexing server for the data file has been received, the association between the data file and the destination indexing server is stored in the cache unit 203. When thereafter the node information requesting unit 201 is about to send another node information request associated with the data file, the lookup unit 202 looks up in the cache unit 203 to determine the destination indexing server associated with the data file. Then, the node information requesting unit 201 will send a type 3 node information request directly to the destination indexing server.

Assuming the destination indexing server is the indexing server 100B. The indexing server 100B is different from the indexing server 100A of the second embodiment in that the message handling unit 104B therein can further discern the type 3 node information request.

Specifically, as shown in FIG. 8, after a request is received, the message handling unit 104B determines its type in step S203B. If it is a type 3 node information request, the process will skip step S208 and S209, and directly proceed to step S204, in which the node information searching unit 105 searches and acquires the node information according to the request, and then in step S205, the node information response is directly sent to the requesting node 200.

Although some specific embodiments of the invention have been described, those skilled in the art can appreciate that various modifications, combinations and alterations may be made to the invention, and the invention covers such modifications, combinations and alterations as fall within the scope of the appended claims.

What is claimed is:

1. An indexing server of a peer-to-peer network, comprising:
a metadata storage unit, which stores one or more entries, each of which is associated with a data file and includes a plurality of information items each indicating a node offering the data file and a location of the node; and
a node information managing unit, which monitors the metadata storage unit to identify an entry stored in the metadata storage unit in which the number of information items exceeds a threshold, and transfers a portion of the information items included in the identified entry to another server, the transferred portion including as many as possible such information items that indicate nodes whose locations are close to each other.

2. The indexing server of claim 1, further comprising a transfer log storage unit, and wherein
when the portion is transferred to another server, the node information managing unit creates or updates a transfer log stored in the transfer log storage unit such that the transfer log reflects the data file associated with the portion, the other server to which the portion is transferred to, and the location range of the node indicated by the information items included the portion.

3. The indexing server of claim 1, wherein the other server is a server determined to have a light load.

4. The indexing server of claim 1, wherein the node information managing unit performs the transfer by dividing the information items included in the identified entry into one or more groups each of which includes information items indicating nodes served by a different Internet Service Provider (ISP), and transferring a group including the largest number of information items among the one or more groups to the other server.

5. The indexing server of claim 1, wherein the node information managing unit performs the transfer by dividing the information items included in the identified entry into one or more groups each of which includes information items indicating nodes served by a different Internet Service Provider (ISP), identifying a group including the largest number of information items among the one or more groups, determining whether the largest number exceeds said threshold, and transferring the identified group to the other server if the largest number does not exceed said threshold, or dividing the information items included in the identified group into one or more subgroups each of which includes information items indicating nodes in a different region, and transferring a subgroup in which the number information items is greatest among the one or more subgroups to the other server, if the largest number exceeds said threshold.

6. The indexing server of claim 1, wherein,
if, after a first information item has been transferred to the other server, a second information item which indicates a node who offers a data file associated with the first information item and whose location is close to a node indicated by the first information item is received, the node information managing unit transfers the second information item to the other server.

7. The indexing server of claim 2, further comprising:
a node information searching unit, which is operable to, according to a request for information regarding nodes offering a specified data file for a requesting node, perform a search in the metadata storage unit and the transfer log storage unit to acquire, from at least one of the metadata storage unit and another server to which a portion of the information items associated with the specified data file has been transferred to, information items that indicate nodes offering the specified data file and are located as close as possible to the requesting node.

8. The indexing server of claim 7, wherein the request specifies the indexing server as a destination indexing server.

9. The indexing server of claim 7, further comprising:
a Distributed Hash Table (DHT) lookup unit, which is operable to, in response to the request, perform a DHT lookup using the identification of the specified data file to determine if a hit occurs on the indexing server, and route the request in a DHT network to which the indexing server belongs if no hit occurs, or cause the node information searching unit to perform said search if the hit occurs.

10. The indexing server of claim 9, wherein the request does not specify the indexing server as a destination indexing server.

11. A method for an indexing server of a peer-to-peer network, the indexing server including a metadata storage unit which stores one or more entries, each of which is associated with a data file and includes a plurality of information items each indicating a node offering the data file and a location of the node, the method comprising the steps of:
monitoring the metadata storage unit to identify an entry stored in the metadata storage unit in which the number of information items exceeds a threshold; and
transferring a portion of information item included in the identified entry to another server, the transferred portion including as many as possible such information items that indicate nodes whose locations are close to each other.

12. The method of claim 11, wherein the indexing server further includes a transfer log storage unit, and the method further comprising:
when the portion is transferred to another server, creating or updating a transfer log stored in the transfer log storage unit such that the transfer log reflects the data file associated with the portion, the other server to which the portion is transferred to, and the location range of the nodes indicated by the information item included in the portion.

13. The method of claim 11, wherein the other server is a server determined to have a light load.

14. The method of claim 11, wherein the step of transferring includes:
dividing the information items included in the identified entry into one or more groups, each of which includes information items indicating nodes served by a different Internet Service Provider (ISP); and
transferring a group including the largest number of information items among the one or more groups to the other server.

15. The method of claim 11, wherein the step of transferring includes:
dividing the information items included in the identified entry into one or more groups each of which includes information items indicating nodes served by a different Internet Service Provider (ISP);
identifying a group including the largest number of information items among the one or more groups;
determining whether the largest number exceeds said threshold; and
transferring the identified group to the other server if said largest number does not exceed said threshold, or otherwise
dividing the information items included in the identified group into one or more subgroups each of which includes information items indicating nodes in a different region, and transferring a subgroup in which the number of information items is greatest among the one or more subgroups to the other server, if said largest number exceeds said threshold.

16. The method of claim 11, further comprising:
if, after a first information item has been transferred to the other server, a second information item which indicates a node who offers a data file associated with the first information item and whose location is close to the node indicated by the first information items included in the transferred portion is received, transferring the second information item to the other server.

17. The method of claim 12, further comprising:
according to a request for information regarding nodes offering a specified data file for a requesting node, perform a search in the metadata storage unit and the transfer log storage unit to acquire, from at least one of the metadata storage unit and another server to which a portion of the information items associated with the specified data file has been transferred to, information items that indicate nodes offering the specified data file and are located as close as possible to the requesting node.

18. The method of claim 17, wherein the request specifies the indexing server as a destination indexing server.

19. The method of claim 17, further comprising:
in response to the request, performing a DHT lookup using the identification of the specified data file to determine if a hit occurs on the indexing server, and routing the request in a DHT network to which the indexing server belongs if no hit occurs, or causing said search to be performed if the hit occurs.

20. The method of claim 19, wherein the request does not specify the indexing server as a destination indexing server.
